(19) United States
(12) Patent Application Publication
(10) Pub. No.: US 2008/0044689 A1
(43) Pub. Date: Feb. 21, 2008

(54) PALLET-TYPE MEMBRANE ELECTRODE ASSEMBLY LAYER STRUCTURE

(76) Inventors: HSI-MING SHU, Taipei (TW); Tsang-Ming Chang, Taipei (TW); Wei-Li Huang, Taipei (TW)

Correspondence Address: G. LINK CO., LTD., 3550 BELL ROAD, MINOOKA, IL, 60447, US

(21) Appl. No.: 11/838,900

(22) Filed: Aug. 15, 2007

(30) Foreign Application Priority Data
Aug. 18, 2006 (TW) 095130358

(51) Int. Cl. H01M 8/00

(52) U.S. Cl. 429/12

(57) ABSTRACT

The present invention discloses a pallet-type membrane electrode assembly layer structure, which comprises an upper frame, at least one membrane electrode assembly, and a lower frame; wherein, the upper frame is provided with at least one first opening; the lower frame is provided with at least one second opening, and the second openings are corresponding to the first openings; and, the membrane electrode assemblies are sandwiched between the corresponding first openings and second openings respectively; in which, the upper frame, the membrane electrode assemblies and the lower frame are sequentially laminated and stacked from top to bottom, and the upper frame, the membrane electrode assemblies and the lower frame are bonded as a single-sheet structure by the supersonic vibration frequency welding means; and, the material for the upper frame and the lower frame is selected with the material suitable for supersonic welding.

### FIELD OF THE INVENTION

The present invention relates to a fuel cell, and particularly to a membrane electrode assembly layer structure for the fuel cell.

### BACKGROUND OF THE INVENTION

US Patent Publication No. US2004/0224190, titled “Fuel cell”, disclosed a fuel cell made of printed circuit board processing. Because US2004/0224190 would employ the adhesives in the fabrication process for fuel cell, and the components of the adhesives suitable for fuel cell is very difficult to acquire, and the process for printed circuit board have to purchase expensive equipment, the manufacturing cost for fuel cell using printed circuit board processing is rather high.

In view of these obvious defects in fabrication process for fuel cell in the prior art and the expectation on the fabrication technology for fuel cell in the industry, the inventor of the present invention has worked hard to invent a pallet-type membrane electrode assembly layer structure for fuel cell, which could employ the supersonic welding means for the fabrication.

### SUMMARY OF THE INVENTION

The main object of the present invention is to provide a pallet-type membrane electrode assembly layer structure, which employs the supersonic welding means for fabrication.

Another object of the present invention is to provide a pallet-type membrane electrode assembly layer structure, which employs a material suitable for supersonic welding as the assembly material.

To this end, the present invention provides a pallet-type membrane electrode assembly structure, which comprises an upper frame, at least one membrane electrode assembly, and a lower frame; wherein, the upper frame is provided with at least one first opening; the lower frame is provided with at least one second opening, and the second openings are corresponding to the first openings; and, the membrane electrode assemblies are sandwiched between the corresponding first openings and second openings; in which, the upper frame, the membrane electrode assemblies and the lower frame are sequentially laminated and stacked from top to bottom, and the upper frame, the membrane electrode assemblies and the lower frame are bonded as a single-sheet structure by the supersonic vibration frequency welding means; and, the material for the upper frame and the lower frame is selected with the material suitable for supersonic welding.

### BRIEF DESCRIPTION OF THE DRAWINGS

The present invention would be detailed described in the following to make the skilled in the art further understand the objects, features, and effects of the present invention with the embodiments and the attached figures wherein:

FIG. 1 is a structural diagram of the pallet-type membrane electrode assembly layer structure according to the present invention;

FIG. 2 is an exploded diagram of the pallet-type membrane electrode assembly layer structure according to the present invention;

FIG. 3 is a structural diagram of the membrane electrode assembly configured with through-holes preferable for supersonic welding operation;

FIG. 4 is a schematic diagram for the vibration area on the upper frame subjected to the supersonic vibration frequency according to the present invention; and,

FIG. 5 is a schematic diagram for the vibration area on the lower frame subjected to the supersonic vibration frequency according to the present invention.

### DETAILED DESCRIPTION OF THE INVENTION

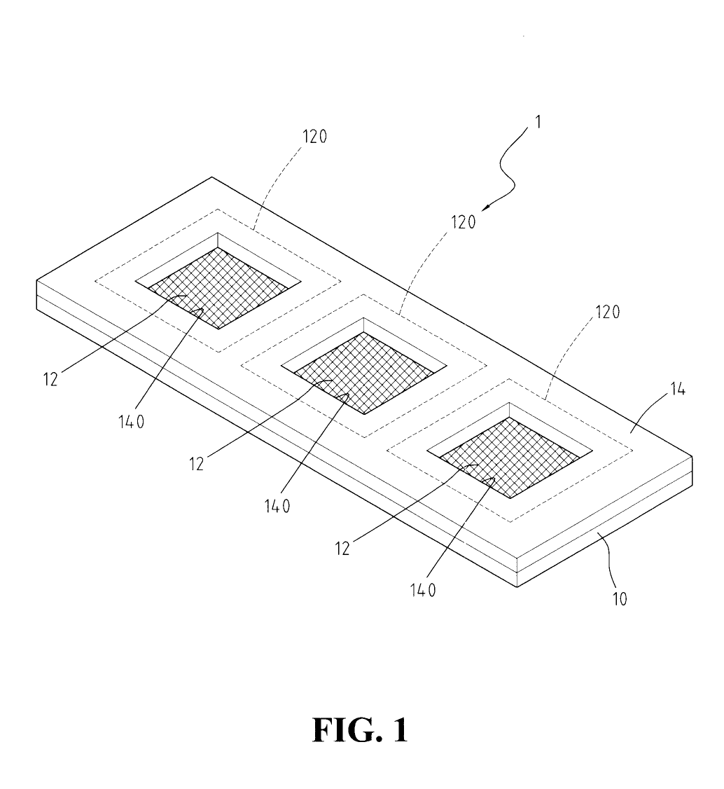

Referring to FIG. 1, the pallet-type membrane electrode assembly layer structure 1 according to the present invention is mainly to sandwich at least one membrane electrode assembly 12 between the upper frame 14 and the lower frame 10. Because the material for the upper frame 14 and the lower frame 10 according to the present invention employs the material suitable for supersonic welding, during the assembly of pallet-type membrane electrode assembly layer structure 1, the present invention employs the supersonic welding means to bond the upper frame 14, the membrane electrode assemblies 12, and the lower frame 10 into a single-sheet structure.

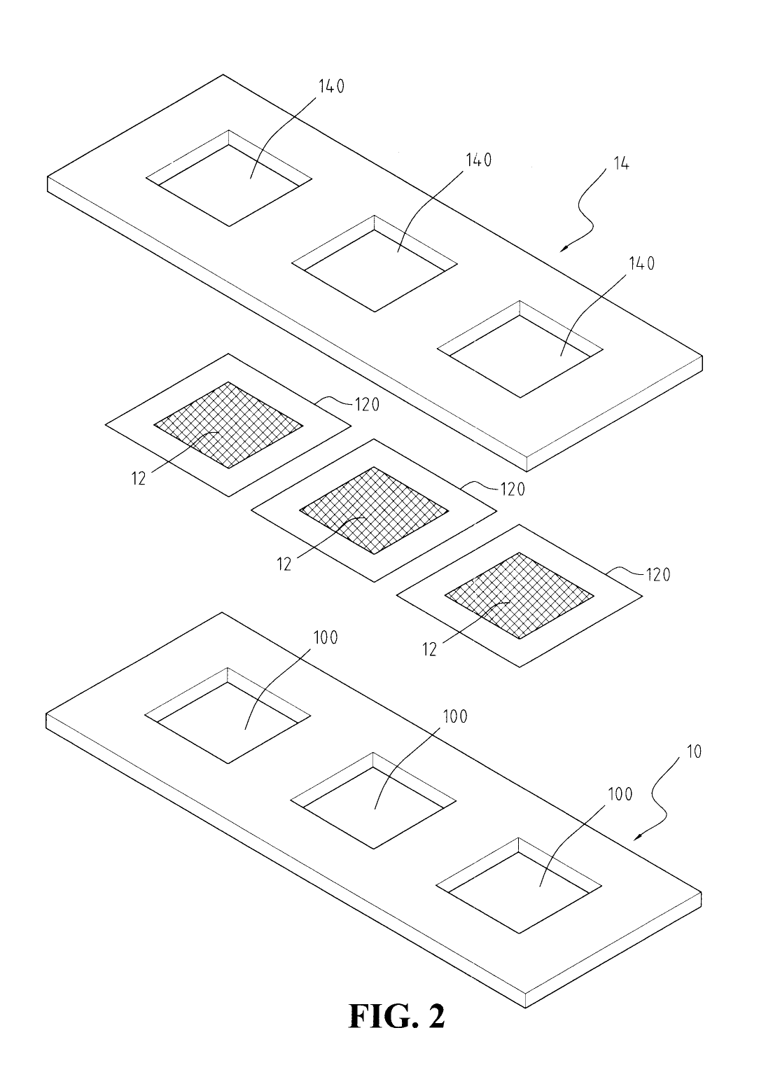

FIG. 1 shows a structural diagram for the pallet-type membrane electrode assembly layer according to the present invention, and FIG. 2 shows an exploded diagram for the pallet-type membrane electrode assembly layer according to the present invention. The pallet-type membrane electrode assembly structure 1 according to the present invention comprises: an upper frame 14, at least one membrane electrode assembly 12, and a lower frame 10, which are described in the following context respectively. The upper frame 14 is configured with at least one first opening 140, and the lower frame 10 is also configured with at least one second opening 100. These first openings 140 and second openings 100 are corresponded in opposite respectively. The shapes for the first opening 140 and the second opening 100 could be configured as quadrilateral, but not limited to.

The membrane electrode assembly 12 could directly employ the conventional membrane electrode assembly, such as the membrane electrode assembly for direct methanol fuel cell, or the membrane electrode assembly for proton exchange membrane. The present invention could directly employ the fabrication technique relating to the conventional membrane electrode assembly. The upper and lower surfaces of the proton exchange membrane 120 are formed with the anode and the cathode, respectively, to obtain the membrane electrode assembly 12. In the mean time, the area of the proton exchange membrane 120 could be slightly larger than the area of the first opening 140 and the second opening 100, so that, for the upper frame 14, the membrane electrode assemblies 12 and the lower frame 10 before the supersonic welding operation, the membrane electrode assembly 12 could be sandwiched between the upper frame 14 and the lower frame 10.

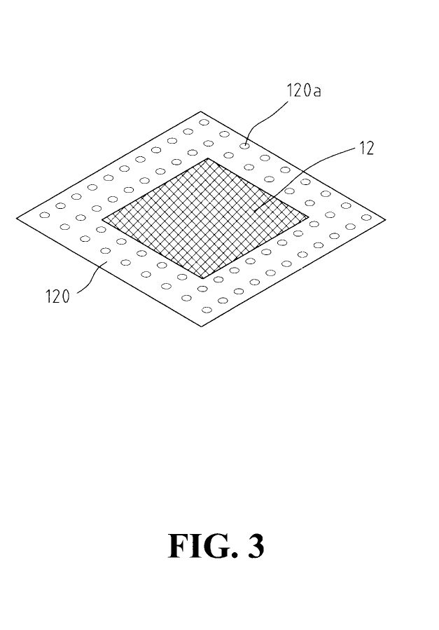

FIG. 3 shows a structural diagram for the membrane electrode assembly configured with through-holes preferable for the supersonic welding operation. The area of the proton exchange membrane 120 not being used as membrane electrode assembly 12 is configured with at least one through-hole 120a. The function of the through-holes 120a is to make the upper frame 14 and the lower frame 10 subjected with the supersonic vibration frequency and melted with the material passing these through-holes 120a to be bonded together. Thus, the membrane electrode assembly 12 could be tightly bonded between the upper frame 14 and the lower frame 10.

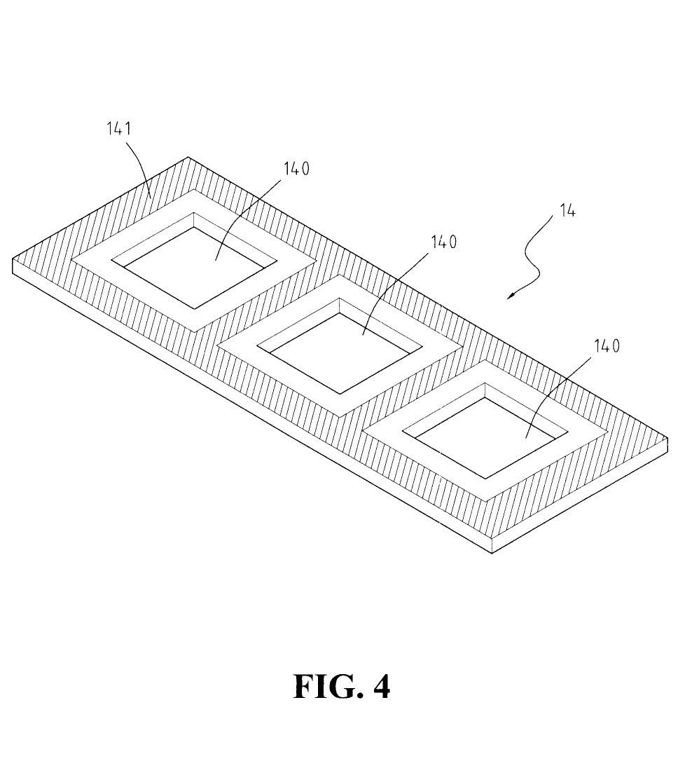

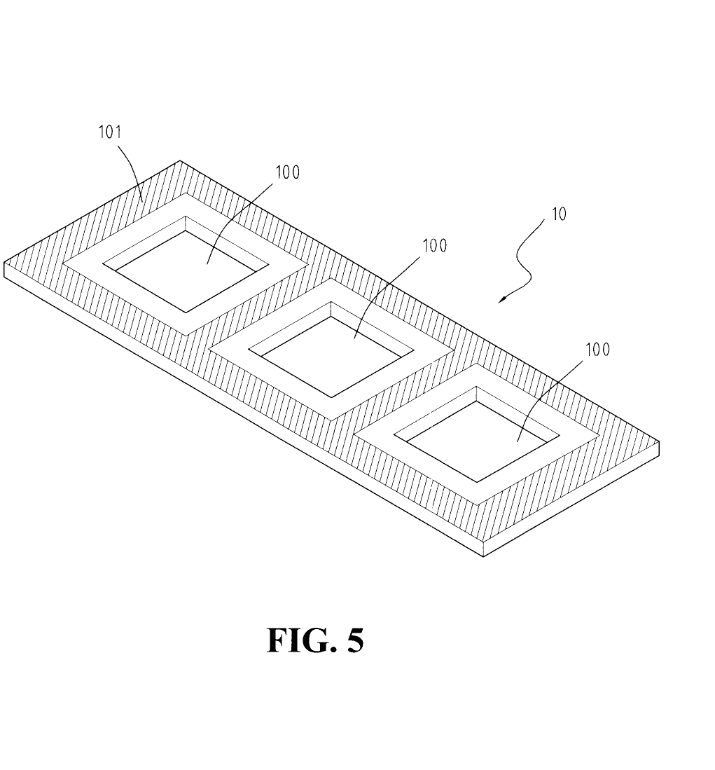

FIG. 4 shows a schematic diagram for the vibration area on the upper frame subjected to the supersonic vibration frequency, and FIG. 5 shows a schematic diagram for the vibration area on the lower frame subjected to the supersonic vibration frequency. The present invention employs the conventional supersonic welding means, such as supersonic wave with 20,000 vibrations per second (20 KHz) or the vibration frequency of 15,000 vibrations per second (15 KHz), to apply onto the vibration area 141 of the upper frame 14 and the vibration area 101 of the lower frame 10. Because the contact friction of vibration areas 141, 101 would generate the thermal energy, the material in the vibration areas 141, 101 would be melted for welding bonding.

The material for the upper frame 14 and the lower frame 10 could be one of PS, SPS, PES, ABS, PC, PP, PPSU, PVO, PSU. Of course, other material suitable for supersonic welding means could also be selected by the present invention, such as thermoplastic industrial plastics with better welding effect.

The thickness of the upper frame 14 and the lower frame 10 could be of 1 mm, but the present invention is not limited to thickness of 1 mm. The operation time for supersonic welding would be about 0.05 second to 1 second, but the present invention is not limited to between 0.05 second to 1 second. The present invention could adjust the suitable supersonic welding operation time according to the material type and the thickness of the upper frame 14 and the lower frame 10.

Moreover, when the material selected to be the material of the upper frame 14 and the lower frame 10 is not provided with anti-acid/anti-erosion physical properties, the present invention could further apply the anti-acid/anti-erosion processing on the surfaces of the upper frame 14 and the lower frame 10, such as coating a thin layer of Teflon on the surfaces of the upper frame 14 and the lower frame 10.

The pallet-type membrane electrode assembly layer structure according to the present invention could achieve the following effects:

1. The present invention could fabricate the membrane electrode assembly layer with a supersonic welding machine, and because the equipment cost for the supersonic welding machine is low, it could greatly reduce the manufacturing cost for the membrane electrode assembly layer; and
2. The pallet-type membrane electrode assembly layer according to the present invention employs the material suitable for supersonic welding as the assembly material, so that, comparing to the assembly material for printed circuit board and the fabrication technique for printed circuit board in the prior art, the present invention provides a whole new membrane electrode assembly layer structure.

The present invention have been described in details with the embodiments as above, and these disclosed embodiments are not used to limit the scope of the present invention. The skilled in the art could have some changes and modification without departing from the spirit and scope of the present invention. The implemented changes and modifications all belong to the scope of the present invention. Thus, the patent protection scope for the present invention should be defined by the attached claims of the application.

What is claimed is:

1. A pallet-type membrane electrode assembly layer structure, which comprises:
an upper frame, in which the upper frame is provided with at least one first opening;
a lower frame, in which the lower frame is provided with at least one second opening, and the second openings are corresponding to the first openings;
at least one membrane electrode assembly, which are sandwiched between the corresponding first openings and second openings;
wherein, the upper frame, the membrane electrode assemblies and the lower frame are sequentially laminated and stacked from top to bottom, and the upper frame, the membrane electrode assemblies and the lower frame are bonded as a single-sheet structure by the supersonic vibration frequency welding means, and the material for the upper frame and the lower frame is selected with the material suitable for supersonic welding.

2. The pallet-type membrane electrode assembly layer structure according to claim 1, wherein membrane electrode assembly is a membrane electrode assembly for direct methanol fuel cell.

3. The pallet-type membrane electrode assembly layer structure according to claim 1, wherein membrane electrode assembly comprises at least one sheet of proton exchange membrane.

4. The pallet-type membrane electrode assembly layer structure according to claim 1, wherein the material for the upper frame is a thermoplastic industrial plastics with better welding effect.

5. The pallet-type membrane electrode assembly layer structure according to claim 1, wherein the material for the lower frame is a thermoplastic industrial plastics with better welding effect.

6. The pallet-type membrane electrode assembly layer structure according to claim 1, wherein the material for the upper frame is one of PS, SPS, PES, ABS, PC, PP, PPSU, PVO, PSU.

7. The pallet-type membrane electrode assembly layer structure according to claim 1, wherein the material for the lower frame is one of PS, SPS, PES, ABS, PC, PP, PPSU, PVO, PSU.

8. The pallet-type membrane electrode assembly layer structure according to claim 1, wherein the surface of the upper frame is further applied with anti-acid/anti-erosion processing if the structure itself is not provided with the anti-acid/anti-erosion physical properties.

9. The pallet-type membrane electrode assembly layer structure according to claim 1, wherein the surface of the lower frame is further applied with anti-acid/anti-erosion processing if the structure itself is not provided with the anti-acid/anti-erosion physical properties.

10. The pallet-type membrane electrode assembly layer structure according to claim 3, wherein the area on the proton exchange membrane not being used as the membrane electrode assembly is configured with at least one through-hole.
